(19) United States
(12) Patent Application Publication
(10) Pub. No.: US 2013/0159089 A1
(43) Pub. Date: Jun. 20, 2013

(54) DISTRIBUTING COUPONS TO USERS OF A SOCIAL NETWORKING SYSTEM USING A NEWSFEED

(71) Applicants: SEBASTIAN GIL, BASKING RIDGE, NJ (US); ROUSSEAU KAZI, MORENO VALLEY, CA (US); ROHIT DHAWAN, SAN FRANCISCO, CA (US); JEFFREY ANDREW KANTER, SAN FRANCISCO, CA (US)

(72) Inventors: SEBASTIAN GIL, BASKING RIDGE, NJ (US); ROUSSEAU KAZI, MORENO VALLEY, CA (US); ROHIT DHAWAN, SAN FRANCISCO, CA (US); JEFFREY ANDREW KANTER, SAN FRANCISCO, CA (US)

(21) Appl. No.: 13/326,336

(22) Filed: Dec. 15, 2011

(51) Int. Cl. G06Q 30/02

(52) U.S. Cl. 705/14.38; 705/14.39

(57) ABSTRACT

A social networking system distributes offers to its users using the social networking users' news feed or another communication channel in the social networking system. To distribute offers, the social networking system receives a post from an advertising user, which includes a coupon or other offer that can be redeemed at a merchant establishment. The post generates an offer story that includes the post with the offer, and an option for claiming the offer. The social networking system sends the offer story to a viewing user of the social networking system, and receives from the viewing user a selection of the option for claiming the offer. To further distribute the offer, the social networking system sends a news story about the viewing user claiming the offer in a feed of news stories to one or more other users of the social networking system who are connected to the viewing user.

### BACKGROUND

The present disclosure relates to distributing electronic offers using a social networking system, and in particular to delivering additional offers via newsfeed stories based on users' interactions with an original offer.

Electronic coupons provide brand-owners and retailers a lower-cost channel to deliver coupons and other electronic offers (“offer”) compared to traditional paper coupons. And, for consumers, electronic coupons provide the added convenience of not having to clip, store, plan usage, and carry coupons to a retailer to redeem the coupon. But, like paper coupons, delivery methods for electronic coupons provide little guarantee that they will reach the intended target consumers.

Coupons distributed using push methods, such as mass e-mails, may not be timely discovered by the consumer to act on the coupon. Alternatively, to improve the timeliness of discovery by consumers, brand-owners and retailers may use pull methods, such as quick response (QR) codes, to enable consumers to capture electronic coupons when the consumer is more interested in redeeming the coupon. To discover electronic coupons linked to QR codes, however, the consumer must first find the QR code. Like discovery of paper coupons, the discovery of QR codes in print ads or other media can be similarly limited.

Furthermore, using mass e-mails or QR codes to deliver electronic coupons fails to efficiently reach targeted consumers and be relevant and timely to them. Limited by a consumer's individual effort to discover electronic coupons, brand-owners and retailers fail to present coupons to all but a few consumers in a manner that is both relevant and timely.

### SUMMARY

Embodiments of the present disclosure use a social networking system to distribute offers to users of the social networking system using the social networking users' news feed or another communication channel in the social networking system. To distribute offers, in one embodiment a post is received from an advertising user at a social networking system. The received post may include an offer or coupon that can be redeemed at a merchant establishment, such as a retail location, associated with the advertising user. The post generates an offer story that includes the post with the offer, and an option for claiming the offer. The social networking system sends a feed containing a plurality of stories, which include the offer story, for display to a viewing user of the social networking system. The social networking system receives from the viewing user a selection of the option for claiming the offer, and sends information for redeeming the offer to at least one of a device of the viewing user and a device associated with the merchant establishment. For example, the device may include the computing device used to claim the offer or another device, such as a mobile phone used to receive the offer. The transmitted information may be suitable for redeeming the offer by the viewing user at a point of sale terminal at the merchant establishment. To further distribute the offer, the social networking system sends a news story about the viewing user claiming the offer in a feed of news stories to one or more other users of the social networking system who are connected to the viewing user.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 illustrates a high level block diagram of a system for delivering offers to users of the social networking system using user news feeds, in accordance with an embodiment.

FIG. 2 illustrates a screenshot of a user interface displaying an exemplary user news feed, in accordance with an embodiment.

FIG. 3 illustrates a high level network diagram of a system for delivering offers to users of the social networking system using user news feeds, in accordance with an embodiment.

FIG. 4 illustrates an event trace diagram for distributing offers to users of the social networking system using user news feeds, in accordance with an embodiment.

FIG. 5 illustrates a flowchart of an exemplary process for delivering offers to users of the social networking system using user news feeds, in accordance with an embodiment.

FIG. 6 illustrates a flowchart of another exemplary process for delivering offers to users of the social networking system using user news feeds, in accordance with an embodiment.

The figures depict various embodiments of the present disclosure for purposes of illustration only. One skilled in the art will readily recognize from the following discussion that alternative embodiments of the structures and methods illustrated herein may be employed without departing from the principles of the embodiments described herein.

### DETAILED DESCRIPTION

### Overview

Embodiments use social networking systems to distribute offers from an advertising user of the social networking system to users of the social networking system using the users' news feeds. Distributing offers, such as coupons, using user news feeds allows offers to be more easily and more rapidly discovered by users not directly connected to a merchant or brand advertising on the social network. Further, because users discover an offer when one of their friends claim the offer, the user that discovers the offer is more likely to also claim the offer. Each time an offer is claimed from a user news feed, this process continues, propagating the offer in a viral manner.

One way embodiments distribute offers from an advertising user of the social networking system to other users of the social networking system is by allowing merchants or third parties advertising on the social networking system to format an offer, such as a coupon, as a page post. The post generates a news feed story, such as an offer story or, more particularly, a coupon story, that includes the post with the offer, and an option for claiming the offer. When a viewing user selects the option for claiming the offer directly from an offer story within the viewing user's news feed, the social networking system sends information for redeeming the offer to at least one of a device of the viewing user and a device associated with the merchant establishment. To further distribute the offer, the social networking system also sends a news story about the viewing user claiming the offer in a feed of news stories to one or more other users of the social networking system who are connected directly or indirectly to the viewing user. This process may repeat each time the offer is claimed, further propagating the offer in a viral manner to users directly or indirectly connected to the merchant's page.

### Offer Distribution System Environment

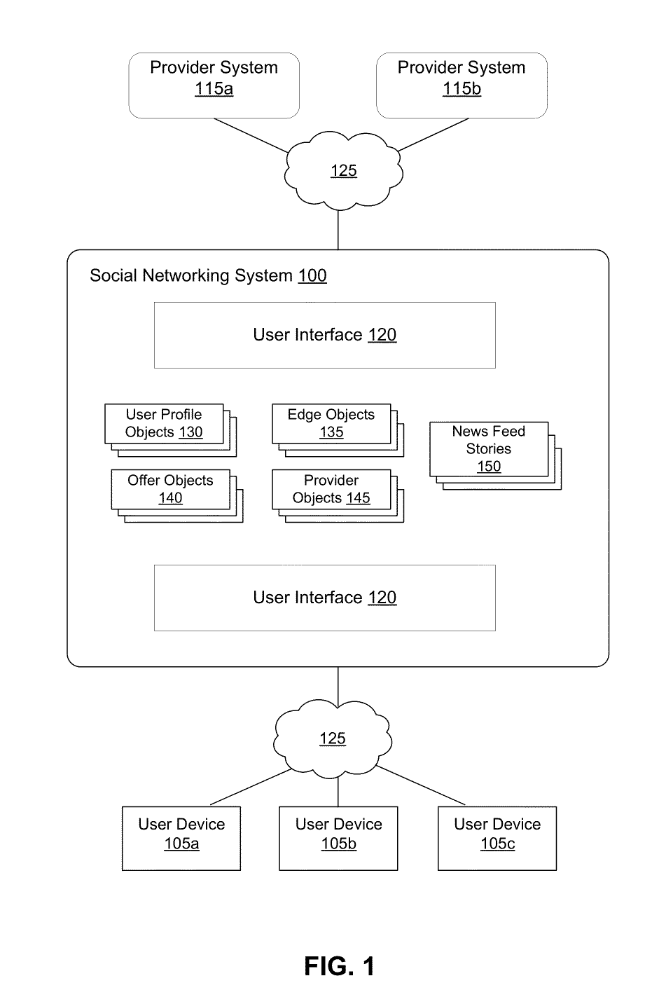

FIG. 1 illustrates a high level block diagram of an exemplary system for delivering offers to users of the social networking system using user news feeds, in accordance with an embodiment. The exemplary system includes social networking system 100, one or more provider systems 115 (also referred to as “provider” herein) coupled to distribute one or more offers to user devices 105 using social networking system 100 and network 125. The exemplary system may be organized in an alternative topology or configuration, and include different and/or additional modules.

FIG. 1 and the other figures use like reference numerals to identify like elements. A letter after a reference numeral, such as “105a,” indicates that the text refers specifically to the element having that particular reference numeral. A reference numeral in the text without a following letter, such as “105,” refers to any or all of the elements in the figures bearing that reference numeral (e.g., “105” in the text refers to reference numerals “105a” and/or “105b” and/or “105c” in the figures).

Social networking system 100 offers its users the ability to communicate and interact with other users of the social networking system 100. Users join the social networking system 100 and then add connections to a number of other users of the social networking system 100 to whom they desire to be connected. As used herein, the term “friend” refers to any other user to whom a user has formed a connection, association, or relationship using social networking system 100. The term friend need not refer to nor require users of social networking system 100 to be actual friends. But instead, it simply implies a connection in social networking system 100. For example, one or more users associated with user devices 105a-c may be a friend of Starbucks®, or a user associated with user device 105a may be friend of another user associated with user device 105c.

Social networking system 100 maintains different types of objects representing entities, for example, user profile objects 130, edge objects 135, offer objects 140, provider objects 145, and news feed stories 150. An object may be stored for each instance of the associated entity. User profile object 130 stores information describing a user of social networking system 100. Edge objects 135 store information describing relations between two users of social networking system 100 or, more generally, any two entities represented in the social networking system 100. Offer objects 140 store information representing offers or coupons offered by one or entities associated with provider system 115. Provider objects 145 store information representing the providers, such as provider name, retail location, store number, and provider product campaign information.

Provider system 115 may be a computing system associated with an advertising user of social networking system 100, such as a merchant, brand-owner, third-party, or other entity engaged in commerce. Provider system 115 may also be associated with other types of social networking system entities, such as a non-profit organization, musician, band, or other non-business entity. In some embodiments, provider system 115 may comprise one or more computing devices that can receive user input and can transmit and receive data via network 125. In one embodiment, provider system 115 is a conventional computer system executing, for example, a Microsoft Windows-compatible operating system (OS), Apple OS X, and/or a Linux distribution. Provider system 115 may interact with social networking system 100 using user interface 100 to create and manage one or more pages in the social network to provide a forum for social networking users that have a common interest in the activities of the advertising user. In some embodiments, provider system 115 may create multiple pages. A page may be created for various merchant locations or store fronts associated provider system 115. For example, Starbucks may create and/or manage a page for each of the over 17,000 Starbucks retail stores worldwide. In another example, a brand-owner, such as Coca-Cola Company may create a page for products (e.g., Coca-Cola®, Diet Coke®, etc.) or product lines (e.g., soft drinks, energy drinks, and sports drinks) In other embodiments, an advertising user of social networking system 100 may be another entity or user acting as an administrator (“admin”) to create and/or manage a page associated with the business establishment where an offer may be redeemed. For example, an admin may create a page and/or manage a provider page, including creating and posting offers as a status update for distribution to other social networking users.

User devices 105 comprise one or more computing devices, such as the computing devices described in reference to provider system 115 that can receive user input and can transmit and receive data via network 125. In another embodiment, user device 105 can be a mobile computing device having computer functionality, such as a tablet computing device, electronic reader, personal digital assistant (PDA), mobile telephone, smart-phone, etc. User device 105 can execute an application, for example, a browser application that allows a user of user device 105 to receive a news feed including one or more news stories from social networking system 100, or otherwise interact with social networking system 100. In another embodiment, user device 105 interacts with social networking system 100 through an application programming interface (API) that runs on the native operating system of the user device 105, such as iOS and ANDROID™.

In one embodiment, network 125 uses standard communications technologies and/or protocols. Thus, network 125 can include wired and/or wireless links using technologies such as Ethernet, 802.11 family of standards, worldwide interoperability for microwave access (WiMAX), 3G, 4G, CDMA, digital subscriber line (DSL), etc. Similarly, the networking protocols used on network 125 can include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over network 125 can be represented using technologies and/or formats including the hypertext markup language (HTML) and the extensible markup language (XML). In addition, all or some of links can be encrypted using conventional encryption technologies such as secure sockets layer (SSL), transport layer security (TLS), and Internet Protocol security (IPsec).

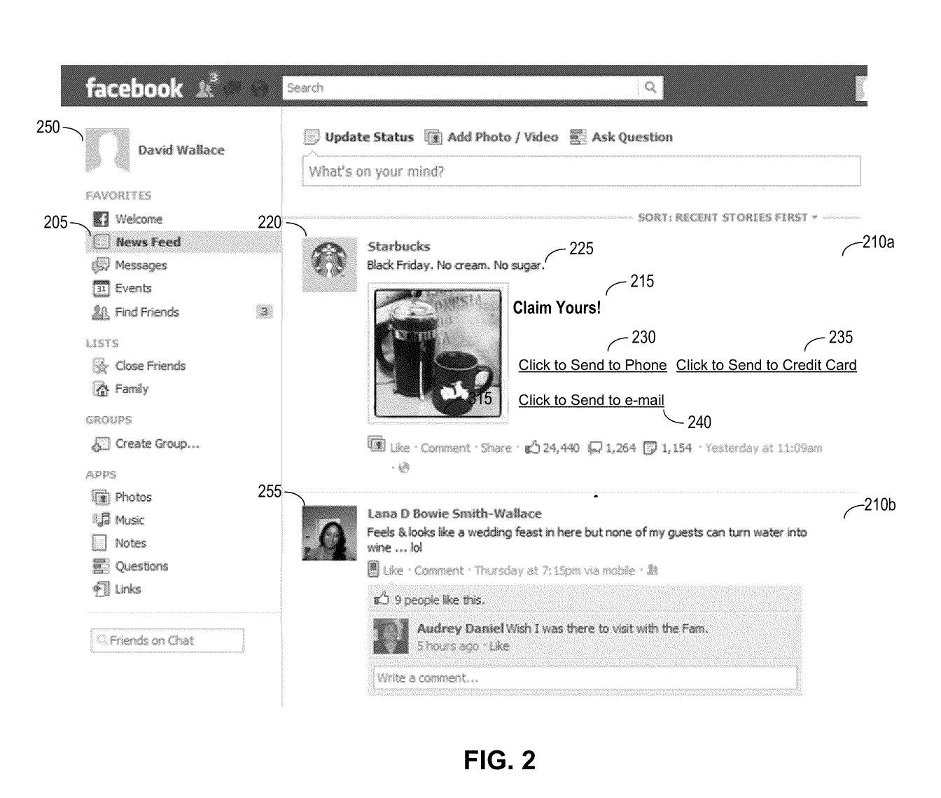

FIG. 2 illustrates a screenshot of a user interface displaying an exemplary user news feed 205 presented to user 250, in accordance with an embodiment. As shown in FIG. 2, user news feed 205 of the viewing user's friends' actions includes one or more news feed stories 210a-b presented to user 205 using user device 105. In some embodiments, a news feed 205 may be a wall/profile page having stories about a particular entity in social networking system 100. Typically, news feed stories presented to the user are updated as and when news feed stories are generated. News feed stories may be generated when connections of the user perform actions. These actions may include, without limitation, posting an image, commenting on a status update or posted image, and a connection of the user adding a new connection. News feed stories may also be associated with entities represented in social networking system 100. Activities of these entities may include posting an offer for merchandise and/or services at reduced cost for distribution to multiple users connected to the entity or users who have otherwise expressed interest in the entity. For example, a connection, such as an advertising user, may post a status update that includes an offer (e.g., a coupon) for redemption at a retail location associated with the advertising user and/or provider 220.

Returning to FIG. 2, provider 220 may be associated with an advertising user of social networking system 100 connected to user 250. Provider 220 may also be associated with other types of social networking system entities, such as a non-profit organization, band, or musician. User news feed 205 includes news feed story 210a generated from activities of provider 220 and news story 210b generated from activities of connected user 255. In some embodiments, news feed story 210a may be an offer story generated when an advertising user associated with provider 220 creates a page post that includes an offer or coupon 215 for display to users connected to the advertising user. Offer 215 may include a text description 225 of the offer. Text description 225 may include discount level, expiration period, redemption location, terms and conditions of use, unique identifier, or other information suitable to redeem the offer. Alternatively or additionally, portions of text description 225 may be displayed prior to a user selecting an option to claim the offer, while other portions of text description 225 may be displayed after a user selects an option to claim the offer. For example, text description 225 may display various discount levels tied to one or more options to claim offer 215 when user 250 mouses-over one of the displayed options 230, 235, and 240. In another example, text description 225 may display various discount levels when user 250 clicks one of the displayed options 230, 235, and 240 to claim offer 215. For example, text description 225 may display a 10% discount when user 250 selects “Click to Send to e-mail” 240, 20% discount when user 250 selects “Click to Send to Phone” 230, and a 30% discount when user 250 selects “Click to Send to Credit Card” 235. In some embodiments, the discount level may be at least based in part on an authenticity score determined by social networking system 100. For example, users having a credit card registered with social networking system 100 may receive a high authenticity score compared to users of social networking system 100 that do not have a registered credit card. As previously discussed, to claim the offer directly from news feed story 210a, offer 215 may include one or more options 230, 235, and 240, by which user 250 may receive or claim the offer. Another option to claim the offer directly from news feed story 210a (not shown) may include claiming the offer using a social networking system message.

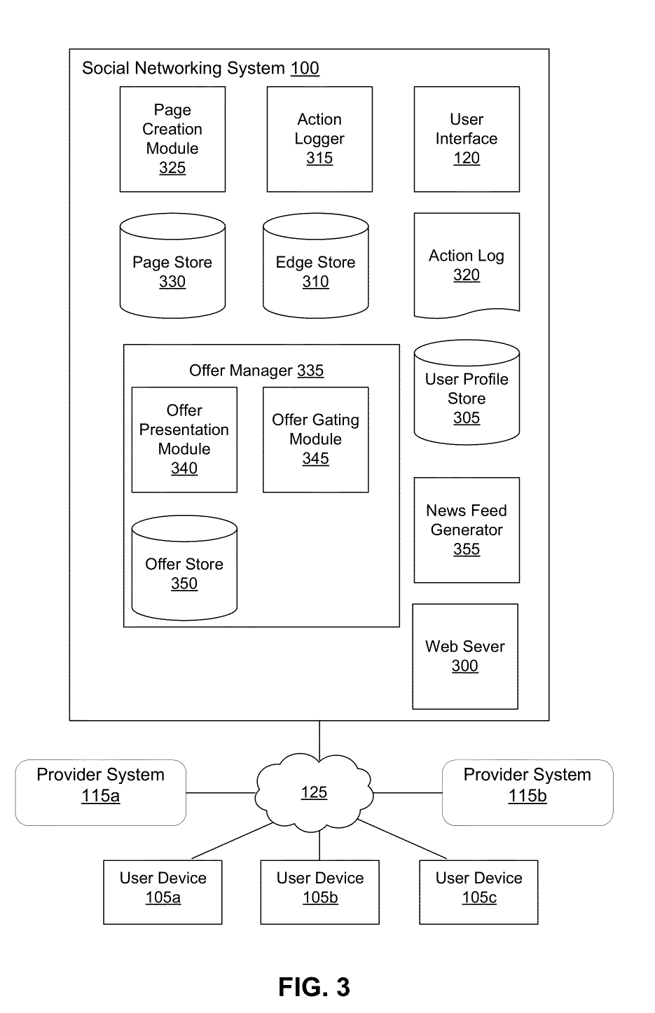

FIG. 3 illustrates a high level network diagram of a system for delivering offers to users of the social networking system using user news feeds, in accordance with an embodiment. Social networking system 100 includes web server 300, user profile store 305, edge store 310, action logger 315, action log 320, page creation module 325, page store 330, and offer manager 335. In other embodiments, the exemplary social networking system 100 may include additional, fewer, or different modules for various applications. Conventional components such as network interfaces, security functions, load balancers, failover servers, management and network operations consoles, and the like are not shown so as to not obscure the details of the system.

Web server 300 links the social networking system 100 via the network 125 to one or more user devices 105 and provider systems 115. Web server 300 serves web pages, as well as other web-related content, such as Java, Flash, XML, and so forth. The web server 300 may provide the functionality of receiving and routing messages between social networking system 100, and user devices 105 and provider system 115, for example, instant messages, queued messages (e.g., e-mail), text and SMS (short message service) messages, or messages exchanged using any other suitable messaging technique. The provider can send a request to web server 300 to upload information, such as status updates, which may include an offer stored in offer store 350. Additionally, web server 300 may provide API functionality to send data directly to native user device operating systems, such as iOS, ANDROID, webOS, and RIM®.

Action logger 315 is capable of receiving communications from web server 300 about user actions performed internal and/or external to social networking system 100. Action logger 315 populates an action log with information about user actions to track them. Such actions may include, for example, posting a status update, adding a connection to the other user, sending a message to the other user, checking-in to the same location that the other user checked-in to, tagging or commenting on an image that includes the other user, reading a message from the other user, sharing links with the other user, viewing content associated with the other user, attending an event posted by the other user, among others. In addition, a number of actions described in connection with other objects are directed at particular users, so these actions are associated with those users as well. Action logger 315 may also populate an action log with information about user's interaction with offer objects 140. Interactions with an offer objects 140 may include viewing the offer, clicking on an image or link to claim the offer, sharing the offer, commenting on the offer, or redeeming the offer.

Action logger 315 may also populate action log 320 with metadata associated with user actions. Metadata may include, for example, temporal data associated with when an action was performed or when an action is intended to be performed, and geographic data associated with the location of where an action was performed or where an action is intended to be performed. Action log 320 records data about users of social networking system 100, including viewing histories, advertisements that were clicked on, offers viewed, purchasing activity, and buying patterns. Similar data recorded for each user of the social networking system may be provided to offer gating module 345 to further target users to receive an offer in a news feed at least based in part on their common interactions on external websites.

User account information and other related information for users are stored as user profile objects 130 in user profile store 305. The user profile information stored in user profile store 305 describes the users of social networking system 100, including biographic, demographic, and other types of descriptive information, such as work experience, educational history, gender, hobbies or preferences, location, and the like. User profile store 305 may also store other information provided by the user, for example, images or videos. In certain embodiments, images of users may be tagged with identification information of users of social networking system 100 displayed in an image. User profile store 305 also maintains references to the actions stored in action log 320 and performed on objects in offer store 350.

Edge store 310 stores the information describing connections between users and other objects on the social networking system 100 in edge objects 135. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 100, such as expressing interest in a page on the social networking system, sharing a link with other users of the social networking system, and commenting on posts made by other users of the social networking system. Edge store 310 may also store data about connections between pages associated with an advertising user. For example, edge store 310 may store information describing the relationship between a parent page for Starbucks and the thousands of child pages for individual Starbucks retail locations. The edge store 310 stores edge objects 135 that include information about the edge, such as affinity scores for objects, interests, and other users. Affinity scores may be computed by social networking system 100 over time to approximate a user's affinity for an object, interest, and other users in social networking system 100 based on the actions performed by the user. Multiple interactions between a user and a specific object may be stored in one edge object in edge store 310, in one embodiment. For example, a user that plays multiple songs from Miles Davis' album, “Kind of Blue,” may have multiple edge objects for the songs, but only one edge object for Miles Davis.

Page creation module 325 may be used to create a new page in the social network. The request to create a new page may be received from a user (or an admin). The request may be activated by a user's check-in to a particular location or business (e.g., retail location associated with provider system 115). A new page request may also be activated when a user clicks on a “create a new page” link or similar type of link in the social networking environment. Page creation module 325 can respond to the user and instruct the user to submit additional information about the topic of interest, such as a name, a category, a sub-category, a photo, a website, a location or an address, etc. In some embodiments, to create an offer for distribution to users of social networking system 100, a user click on a “create offer” link or tab within the “create a new page” process. Page creation module 325 may respond to the user's request to create an offer by instructing the user to submit information about the offer including, for example, a text description of the offer, image, expiration date, unique offer code, maximum number offers issuable to a user, maximum number of offers issuable per product campaign via send to phone using short message service (SMS), via send to credit card, and via send to e-mail. Information about the offer may also include discount level, retail locations for redeeming the offer, and links for the user to select an option to claim the offer as previously described. Page creation module may submit information about the new page and the offer for storage in page store 330, and pass the data along to offer manager 335 for processing.

Offer manager 335 is configured to distribute offers using news feed generator 355. Offer manager 335 may include, among other components, offer presentation module 340, offer gating module 345, and offer store 350. Offer manager 335 may receive pages associated with providers and stored in page store 330, and process the received pages to identify offers included in pages. Pages that include offers may be identified by a flag set when the “create offer” link is activated, or by other methods known by those of ordinary skill in the art. Identified offers may be stored in offer store 350. Offer store 350 may also store information (e.g., user demographics) on offers presented and claimed by users. Offer store 350 may also include third-party offers not generated by using the “create offer” link, but instead, submitted to social networking system 100 in a predetermined format. For example, in some embodiments, user interface 120 may include an interface for submitting offers for distribution to users of social networking system 100. The interface may prompt the user to input information describing the offer as previously described.

Offer gating module 345 may limit which users receive offers within a news feed based on geographic proximity to one or more retail locations associated with a provider or merchant location where the offer may be redeemed. For example, offer gating module 345 may limit the distribution of an offer for “15% off a dinner for two at the Slanted Door restaurant in San Francisco, Calif.” to users located within forty miles of the Slanted Door restaurant in San Francisco. In some embodiments, offer gating module 345 may determine a user's location based on user information stored in user profile (e.g., current city or hometown). In other embodiments, offer gating module 345 may determine a user's location based on geo-location information stored in action log 320 (e.g., check-in location information). Offer gating module 345 may further limit which users receive offers within a news feed based on other targeting criteria, such as an indication of interest in the object of offer based on previous interactions with users of social networking system 100 stored in action log 320. For example, offer gating module 345 may limit distribution of an offer based in part on an affinity for the provider or an affinity for the subject matter of the offer.

Offer presentation module 340 may be further configured to present offers to news feed generator 355 for delivery of users. News feed generator 355 generates news feed stories for presentation to users of social networking system 100. The user to whom a news feed story is presented is referred to a as a viewer of the news feed story or a viewing user. In an embodiment, news feed generator 355 analyzes information stored in action log 320 to identify information useful for generating news feed stories 150. News feed generator 355 identifies actions stored in action log 320 that are likely to be of interest to viewers and extracts information describing these action from action log 320 to generate news feed stories 150. For example, user actions, such as claiming an offer directly from an offer story as described with reference to FIG. 2, may be captured and stored in action log 320, and extracted by news feed generator 355 for presentation to users connected to user 250. News feed generator 355 may repeat this action each time a user of social networking system 100 claims an offer from an offer story included in the user's news feed.

Alternatively, news feed generator 355 may obtain information describing action from other modules, for example, from action logger 315 or other run time modules that implement functionality for performing different types of actions. For example, if a user uploads an image to social networking system 100, the module executing the code for uploading the image can inform news feed generator 355 of the action so that news feed generator 355 can generate a news feed story describing the action.

News feed generator 355 may determine that certain actions are not likely to be of interest to users for reporting as news feed stories 150. For example, a user hiding a comment posted by another user or a user changing certain types of user preferences may not be of interest to other users and is therefore not reported in news feed stories. However, other changes made by a user to the user's profile may be considered interesting for other users, for example, a change in relationship status of a user.

News feed generator 355 may not generate news feed stories based on certain actions as a matter of policies enforced by social networking system 100. For example, a user viewing user profile of another user or a user sending a private message to another user may not be presented as news feed stories due to privacy concerns. Furthermore, news feed generator 355 may consider privacy settings of individual users to determine whether certain actions of a user can be presented as news feed stories to other users. A user may set the user's privacy settings to limit the set of people to whom news feed stories describing the user's actions may be sent. For example, a user may allow only connections of the user to receive information describing the users' actions, whereas another user may allow connections of the user's connections to receive the information. A user may restrict the types of actions that are reported as news feed stories. For example, the user may specify that certain actions, for example, adding a new connection may not be reported as news feed stories.

### Distributing an Offer Using User News Feeds

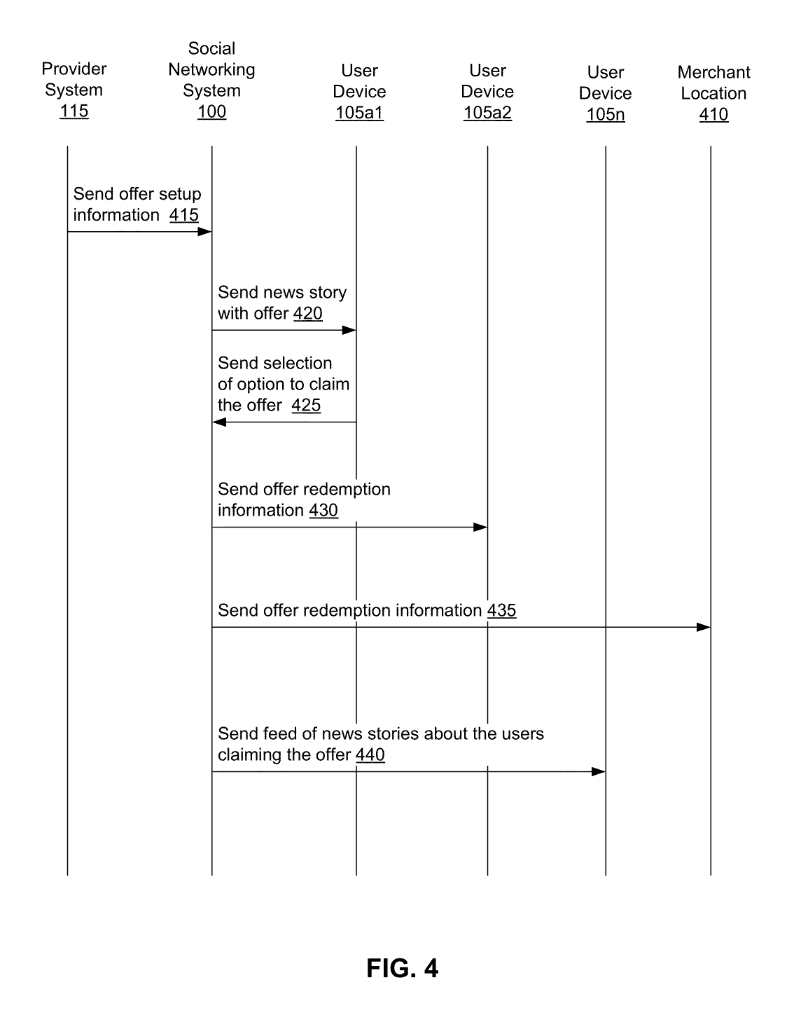

FIG. 4 illustrates an event trace diagram for distributing offers to users of the social networking system using user news feeds. The event trace in FIG. 4 describes the interaction between provider system 115, social networking system 100, user devices 105a1 and 105a2 associated with a viewing user of social networking system 100, user device(s) 105n associated with one or more users of social networking system 100 who are connected to the viewing user, and a merchant location 410 where the offer may be redeemed.

Provider system 115 sends 415 offer setup information to social networking system 100. To setup the offer, an advertising user or third-party associated with provider system 115 creates an offer associated with a page in the social network or submits an offer to social networking system 100 in a predetermined format using user interface 120. In the setup, the advertising user or third-party may include for example, a text description of the offer, discount level, expiration date, unique offer code, maximum number offers issuable to a user, options to claim the offer, and maximum number of offers issuable based in part on which option to claim the offer is selected.

When the advertising user or third-party completes the offer setup, social networking system 100 attaches the offer to a page status update and sends 420 the update as a post with the offer and an option for claiming the offer to a viewing user. The viewing user may receive the post as an offer story included in a feed of a plurality of stories on user device 105a1. User device 105a1 may be desktop computing device, such as a personal computer or laptop computer, or similar computing device suitable to interface with social networking system 100 and to interact with the offer story as previously described.

The viewing user may send 425 a selection for an option to claim the offer using user device 105a1 to social networking system 100. For example, the viewing user may click on one of the following options included in the offer story for claiming the offer: (1) “Click to Send to Phone”; (2) “Click to Send to e-mail”; or (3) “Click to Send to Credit Card.” In some embodiments, the viewing user by selecting “Click to Send to Phone” may elect to send the offer to another user device (e.g., user device 105a2, which may be a mobile phone or a smart-phone). In other embodiments, the viewing user may elect to send the offer to same device used to select the option to claim the offer. In one embodiments, responsive to receiving the selection of the option to claim the offer from the viewing user, social networking system 100 sends 430 information for redeeming the offer to either user device 105a1 or 105a2.

In another embodiment, the viewing user may send a selection of an option to claim the offer using user device 105a1 to social networking system 100. For example, the viewing user may click on “Click to Send to Credit Card.” Responsive to receiving the selection form the viewing user for claiming the offer, social networking system 100 sends information for redeeming the offer to credit card system and merchant location 410. In some embodiments, the transmitted information may include credit card information associated with the viewing user. The credit card information may be encrypted using a hash function or other encryption method suitable to protect the credit card information from detection during transmission to the credit card system and/or merchant location 410. The credit card information may be decrypted at the point of sale terminal at merchant location 410, and matched with the viewing user's credit card when the viewing user redeems the offer at merchant location 410. By doing so, the discount value associated with the offer is applied automatically during the transaction.

As previously mentioned, social networking system 100 also sends 435 information for redeeming the offer to merchant location 410. In some embodiments, the transmitted information may be suitable for redeeming the offer by the viewing user at a point of sale terminal at the merchant establishment. For example, the transmitted information may include a discount level, product identifier, or unique offer code. To further distribute the offer in a viral manner, social networking system 100 sends 440 a news story about the viewing user claiming the offer in a feed of news stories to one or more other users of the social networking system who are connected to the viewing user.

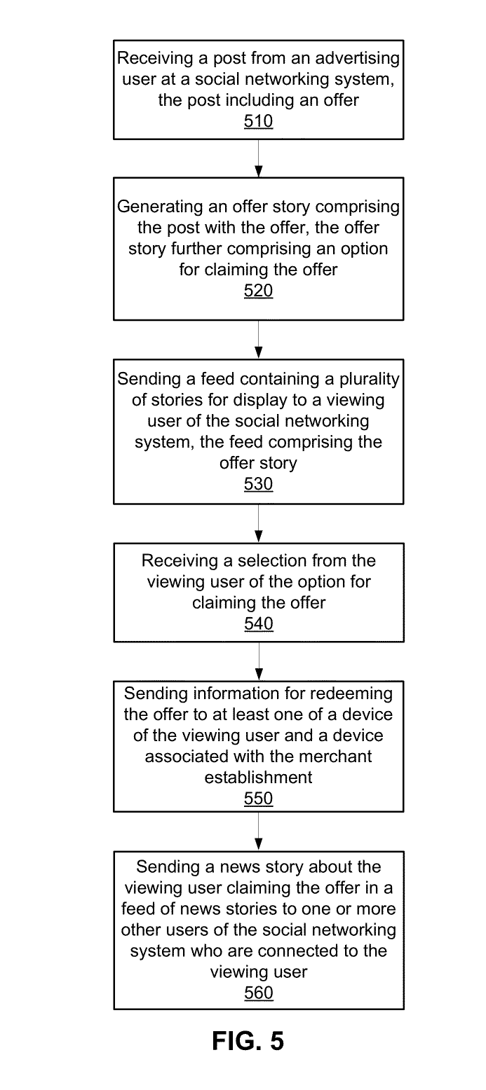

FIG. 5 illustrates a flowchart of an exemplary process for delivering offers to users of the social networking system using user news feeds, in accordance with an embodiment. Social networking system 100 receives 510 a post from an advertising user. The post may include an offer or an offer for redemption at a merchant establishment associated with the advertising user. In some embodiments, the advertising user may be an admin of a page associated with merchant establishment or retail location where the offer may be redeemed. Social networking system 100 generates 520 an offer story comprising the post with the offer. The offer story includes an option for claiming the offer. For example, the option may be presented in the offer story as: (1) “Click to Send to Phone”; (2) “Click to Send to e-mail”; or (3) “Click to Send to Credit Card.” When the viewing user selects “Click to Send to Phone,” social networking system 100 may send the redemption information to a user device using SMS or other protocol suitable to transmit redemption information to a user device. Selecting “Click to Send to e-mail” causes social networking system 100 to send the redemption information to the viewing user in a e-mail format. Because the redemption is in an e-mail format, it may be later retrieved by the viewing user using a mobile computing device suitable to present the redemption information at merchant location to redeem the offer. Selecting “Click to Send to Credit Card” causes social networking system 100 to send credit card information registered in social networking system 100 and associated with the viewing user to the merchant location where the offer may be redeemed.

In some embodiments, in response to receiving a selection of an option to claim an offer, social networking system 100 may access previously logged information to complete the claim process for the convenience of the social networking system user. For example, social networking system 100 may access phone numbers, e-mail addresses, credit card information, or other personalized data previously registered with social networking system 100 and used by social networking system 100 or a merchant establishment to enable a user to claim an offer. In some embodiments, such information may be logged in social networking system 100 with a social networking system user's informed consent to do so.

Social networking system 100 sends 530 a feed containing a plurality of stories and the offer story for display to a viewing user of social networking system 100. In some embodiments, the feed may be a news feed of the viewing user's friends' actions. In other embodiments, the feed may be a wall or profile page having stories about a particular entity in social networking system 100. Social networking system 100 receives 540 a selection from the viewing user of the option for claiming the offer. Responsive to receiving the selection from the viewing user for claiming the offer, social networking system 100 sends 550 information for redeeming the offer to a device of the viewing user and a device associated with the merchant establishment (e.g., point of sale terminal). In some embodiments, the device of the viewing user may be the same device used to select the option for claiming the offer. In other embodiments, the device of the viewing user may be a different device than the device used to select the option for claiming the offer. Social networking system 100 sends 560 a news story about the viewing user claiming the offer in a feed of news stories to one or more other users of social networking system 100 who are connected to the viewing user.

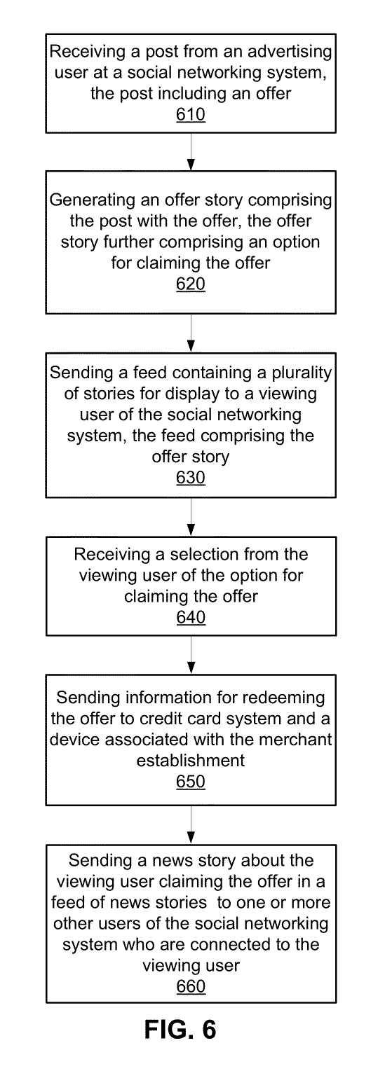

FIG. 6 illustrates a flowchart of another exemplary process for delivering offers to users of the social networking system using user news feeds, in accordance with an embodiment. Social networking system 100 receives 610 a post from an advertising user. The post may include and offer or an offer for redemption at a merchant establishment associated with the advertising user. In some embodiments, the advertising user may be an admin of a page associated with merchant establishment or retail location where the offer may be redeemed. Social networking system 100 generates 620 an offer story comprising the post with the offer. The offer story includes an option for claiming the offer. For example, the option may be presented in the offer story as: (1) “Click to Send to Phone”; (2) “Click to Send to e-mail”; or (3) “Click to Send to Credit Card.” When the viewing user selects “Click to Send to Phone,” social networking system 100 may send the redemption information to a user device using SMS or other protocol suitable to transmit redemption to a user device. Selecting “Click to Send to e-mail” causes social networking system 100 to send the redemption information to the viewing user in a e-mail format. Selecting “Click to Send to Credit Card” causes social networking system 100 to send credit card information registered in social networking system 100 and associated with the viewing user to the merchant location where the offer may be redeemed.

Social networking system sends 630 a feed containing a plurality of stories and the offer story for display to a viewing user of the social networking system. In some embodiments, the feed may be a news feed of the viewing user's friends' actions. In other embodiments, the feed may be a wall or profile page having stories about a particular entity in social networking system 100. Social networking system 100 receives 640 a selection from the viewing user of the option for claiming the offer. Responsive to receiving the selection from the viewing user for claiming the offer, social networking system 100 sends 650 information for redeeming the offer to a credit card system and/or a device associated with the merchant establishment. In some embodiments, the credit card information may be encrypted using a hash function or other encryption method suitable to protect the credit card information from detection during transmission to credit card system and merchant location. The credit card information may be decrypted at the point of sale terminal at merchant location, and matched the viewing user's credit card when the viewing user redeems the offer at merchant location. Social networking system 100 sends 660 a news story about the viewing user claiming the offer in a feed of news stories to one or more other users of the social networking system who are connected to the viewing user.

Summary

The foregoing description of the embodiments has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the embodiments be limited not by this detailed description, but rather by any claims that issue on an application based hereon. Accordingly, the disclosure of the embodiments is intended to be illustrative, but not limiting, of the scope of the disclosure, which is set forth in the following claims.

What is claimed is:

1. A method comprising:
receiving a post from an advertising user at a social networking system, the post comprising a coupon for redemption at a merchant establishment associated with the advertising user;
generating a coupon story comprising the post with the coupon, the coupon story further comprising an option for claiming the coupon;
sending a feed containing a plurality of stories for display to a viewing user of the social networking system, the feed comprising the coupon story;
receiving a selection from the viewing user of the option for claiming the coupon;
responsive to receiving the selection from the viewing user for claiming the coupon, sending information for redeeming the coupon to at least one of a device of the viewing user and a device associated with the merchant establishment, the transmitted information suitable for redeeming the coupon by the viewing user at a point of sale terminal at the merchant establishment; and
sending a news story about the viewing user claiming the coupon in a feed of news stories to one or more other users of the social networking system who are connected to the viewing user.

2. The method of claim 1, wherein the advertising user at the social networking system comprises an admin of a page associated with a merchant where the coupon is redeemable.

3. The method of claim 1, wherein the feed is a news feed of the viewing user's friends' actions.

4. The method of claim 1, wherein the feed is a page associated with a merchant where the coupon is redeemable.

5. The method of claim 1, wherein the feed is a profile page containing stories about an entity in the social networking system.

6. The method of claim 1, wherein the at least one of the device of the viewing user comprises a device that is different from the device of the viewing user from which the selection for claiming the coupon was received.

7. The method of claim 1, wherein the at least one of the device of the viewing user comprises a device that is the same as the device of the viewing user from which the selection for claiming the coupon was received.

8. The method of claim 1, wherein the information for redeeming the coupon is sent to the viewing user using a short message service (SMS) protocol.

9. The method of claim 1, wherein the information for redeeming the coupon is sent to the viewing user using e-mail.

10. The method of claim 1, wherein the information for redeeming the coupon is sent to a device of the viewing user that is different from the device of the viewing user from which the selection for claiming the coupon was received.

11. The method of claim 1, further comprising sending the news story about each viewing user claiming the coupon in the feed of news stories to one or more other users of the social networking system who are connected to the viewing user each time the coupon is claimed.

12. A method comprising:
receiving a post from an advertising user at a social networking system, the post comprising a coupon for redemption at a merchant establishment associated with the advertising user;
generating a coupon story comprising the post with the coupon, the coupon story further comprising an option for claiming the coupon;
sending a feed containing a plurality of stories for display to a viewing user of the social networking system, the feed comprising the coupon story;
receiving a selection from the viewing user of the option for claiming the coupon;
responsive to receiving the selection from the viewing user for claiming the coupon, sending information for redeeming the coupon to a credit card system, the transmitted information suitable for redeeming the coupon by the viewing user at a point of sale terminal at the merchant establishment; and
sending a news story about the viewing user claiming the coupon in a feed of news stories to one or more other users of the social networking system who are connected to the viewing user.

13. The method of claim 12, wherein the advertising user at the social networking system comprises an admin of a page associated with a merchant where the coupon is redeemable.

14. The method of claim 12, wherein the feed is a news feed of the viewing user's friends' actions.

15. The method of claim 12, wherein the feed is a page associated with a merchant where the coupon is redeemable.

16. The method of claim 12, wherein the feed is a profile page containing stories about an entity in the social networking system.

17. The method of claim 12, further comprising sending the news story about each viewing user claiming the coupon in the feed of news stories to one or more other users of the social networking system who are connected to the viewing user each time the coupon is claimed.

18. A method comprising:
receiving an offer from an advertiser at a social networking system, the offer redeemable at a merchant establishment associated with the advertiser;
generating a coupon story comprising the offer, the coupon story further comprising an option for claiming the offer;
sending the coupon story for display to a viewing user of the social networking system;
receiving a selection from the viewing user of the option for claiming the offer;
responsive to receiving the selection from the viewing user for claiming the offer, sending information for redeeming the offer to at least one of a device of the viewing user and a device associated with the merchant establishment, the transmitted information suitable for redeeming the offer by the viewing user at the merchant establishment; and
sending a news story about the viewing user claiming the offer in a feed of news stories to one or more other users of the social networking system who are connected to the viewing user.

19. The method of claim 18, wherein the feed is a news feed of the viewing user's friends' actions.

20. The method of claim 18, wherein the feed is a page associated with a merchant where the offer is redeemable.

21. The method of claim 18, wherein the feed is a profile page containing stories about an entity in the social networking system.

22. The method of claim 18, wherein the at least one of the device of the viewing user comprises a device that is different from the device of the viewing user from which the selection for claiming the offer was received.

23. The method of claim 18, wherein the at least one of the device of the viewing user comprises a device that is the same as the device of the viewing user from which the selection for claiming the offer was received.

24. The method of claim 18, wherein the information for redeeming the offer is sent to the viewing user using a short message service (SMS) protocol.

25. The method of claim 18, wherein the information for redeeming the offer is sent to the viewing user using e-mail.

26. The method of claim 18, further comprising sending the news story about each viewing user claiming the offer in the feed of news stories to one or more other users of the social networking system who are connected to the viewing user each time the offer is claimed.
